(19) United States
(12) Patent Application Publication
(10) Pub. No.: US 2009/0207755 A1
(43) Pub. Date: Aug. 20, 2009

(54) METHOD OF CONFIGURING NETWORKS, IN PARTICULAR ETHERNET SWITCHES

(76) Inventor: Andreas Walden, Pliezhausen (DE)

Correspondence Address: K.F. ROSS P.C., 5683 RIVERDALE AVENUE, SUITE 203 BOX 900, BRONX, NY, 10471-0900, US

(21) Appl. No.: 12/340,798

(22) Filed: Dec. 22, 2008

(30) Foreign Application Priority Data
Dec. 22, 2007 (DE) 102007062493.1

(51) Int. Cl. H04L 12/28

(52) U.S. Cl. 370/254

(57) ABSTRACT

Network devices are configured by displaying an input mask for entering configuration data appears on a display of the network device or a configuration device to be connected to the network device and representing the input mask in at least two different formats. The configuration data is entered in the formats with the same content. Thereafter the inputted data is further processed in various data formats depending on the format of the input mask.

The invention relates to a method of configuring network devices, in particular Ethernet switches, according to the features of the preamble of claim 1.

Networks are known from the prior art, in particular for industrial automation, in which various network devices such as switches, routers, hubs, PCs, and the like are provided. Data transmission in such networks may be performed according to the Ethernet standard, for example, or also according to some other standard.

For starting up such a network together with its network devices, or also for replacing such devices, whether for upgrading or for correction of defects, it is necessary to configure a network device. In other words, various data must be entered into the network device, depending on the application and the site of installation. These data are also referred to as configuration data, and may involve, for example, an IP address, a MAC address, the name or location of the device, the access rights of the device, and the like.

It is therefore necessary to enter such configuration data into the network device, using an appropriate input unit, or to modify configuration data that have already been entered and stored. For this purpose, either the network device itself has a display, or a configuration device, a PC, for example, that may be connected to the network device has such a display. Using the appropriate input unit, in particular a keyboard that is connected to the network device or the configuration device, access can be had to an input mask via a corresponding command by an operator, for example a system administrator.

The object of the invention is to provide a method of configuring network devices, by means of which the entry of configuration data for configuring the network device is improved.

This object is attained by the features of claim 1.

According to the invention the input mask is in at least two, preferably exactly two, different formats, and the configuration data entered in the two formats has the same content, and after entry the inputted data are further processed in various data formats, depending on the format of the input mask.

The invention thus provides one input mask in each of at least two different formats, and the operator may fill the input masks with the configuration data. The newly entered and/or modified configuration data are then processed further, in particular transmitted, and stored in a memory. This memory may be situated in the network device itself or in a different location.

The improvement lies in the fact that since, for example, one format is a Web-based format, in particular HTML and the other is DOS, the user has improved access to various representations of the input mask in order to enter data. On the one hand, the convenience of entry is adapted to the habits of the user. That is, some users prefer to enter the data in a Web-based format, whereas other users prefer to enter data in a DOS format. On the other hand, an additional advantage is that the data entered, depending on the format of the input mask, may be further processed in various data formats. This allows a greater variety of design for the standards of the network infrastructure.

In one refinement of the invention, switching is performed between the two formats of the input mask, using a controller. It is thus possible, for example, for one user to use an input mask in one format, and for another user to use the input mask in the other format, or for the same user to switch back and forth between the two formats. In any event this ensures, regardless of which format is used to enter the data into the input mask, that these data are further processed, in particular transmitted and stored, in the particular data format, and subsequently may be displayed once again in the respective format of the input mask.

In one refinement of the invention, the data entered into the respective input masks are transmitted in the different data formats via a remote data connection between the network device and the configuration device, for example the PC or a notebook. This has the advantage that the user does not have to be present at the location of the network device in order to reconfigure or modify a configuration of a network device. The user may access the network device via a remote data connection, and is able to retrieve the particular input mask in the desired format on the user's configuration device.

1. A method of configuring network devices, comprising the steps of:
displaying an input mask for entering configuration data appears on a display of the network device or a configuration device to be connected to the network device,
representing the input mask in at least two different formats, and
entering the configuration data in the formats with the same content, and
thereafter further processing the inputted data in various data formats, depending on the format of the input mask.

2. The method according to claim 1 wherein one format is a Web-based format and the other format is DOS.

3. The method according to claim 1 2 wherein a controller switches between the two formats of the input mask.

4. The method according to claim 1, further comprising the step of:
transmitting the data entered into the respective input masks in the different data formats via a remote data connection between the network device and the configuration device.

5. The method according to claim 1 wherein the input mask may be represented in exactly two different formats, and the entry of the configuration data in the two formats is performed with the same content, and after entry the inputted data are further processed in various data formats, depending on the format of the input mask.
